(19) United States
(12) Patent Application Publication
(10) Pub. No.: US 2011/0319146 A1
(43) Pub. Date: Dec. 29, 2011

(54) CELLULAR PHONE PROTECTOR

(76) Inventor: Maggie Wilford, Sikeston, MO (US)

(21) Appl. No.: 12/821,417

(22) Filed: Jun. 23, 2010

(51) Int. Cl. H04W 88/02

(52) U.S. Cl. 455/575.8

(57) ABSTRACT

An enclosure for storing an electronic device comprising: a body portion where the body portion includes a top portion and a bottom portion; a means to sealed together and enclose the top portion and bottom portion; and a power cord, where said power cord extends from the bottom portion of the enclosure and said power cord includes a connector. The connector enables the connection of the enclosure into a DC outlet of the vehicle.

### BACKGROUND OF THE INVENTION

1. Field of Invention

The present invention relates to a cell phone protector that provides a climate-controlled environment to store a cell phone.

2. Description of Related Art

Various electronic devices use by individuals and have become very prevalent in everyone's daily life. Examples of electronic devices used by individuals include PDAs, cell phones, smart phones, iPods, MP3 players and other small electronic devices which are portable and principally used for communication and entertainment purposes. Individuals transport these devices and generally carry the device in their pocket or in a case designed to attach to the individual's belt or other apparel worn by the person. These type of electronic devices are very portable due to the use of batteries to charge the devices, therefore they are very frequently transported in a vehicle. Many of the devices may also include either wired or wireless communication accessories such as earplugs or Bluetooth earphones. Consequently all the components of the device are used together and transported with the user.

Occasionally the user of such an electronic device may need to leave the device in a vehicle because it may not be permitted in their eventual destination such as a workplace, hospital or courthouse. If an electronic device is left in the vehicle it is consequently exposed to the environmental conditions within the vehicle. The environmental conditions are therefore subject to the existing weather conditions and in certain instances may expose the interior of the vehicle to extreme heat or cold. Such extreme temperatures can be detrimental to the electronic device and therefore affect the functioning thereof or destroy the functionality of the device. Further many times an individual cannot avoid leaving the device in their vehicle.

Protective cases and enclosures have been developed for these electronic devices in particular for cell phones. Many variations of cell phone cases are currently on the market, however they are primarily protective-type cases or decorative-type cases. These cases normally protect the cell phone from damage if the device is dropped or exposed to chemicals, water, dirt, grease or grime. One example of a protective enclosure for a cell phone is disclosed in U.S. Pat. No. 6,701,159 which discloses a protective enclosure for a rectangular-shaped cell phone that may include an external antenna where the enclosure includes a webbed portion covering the front, sides, top and bottom of the cell phone.

Such protective devices are insufficient in shielding the cell phone from extreme environmental conditions that may occur within a vehicle. Consequently it would be advantageous to have an enclosure to place a cell phone or other electronic device for storage within a vehicle to protect it from the environmental conditions that may arise within the vehicle.

### SUMMARY OF THE INVENTION

The present invention relates to an enclosure for storing an electronic device comprising: a body portion where the body portion includes a top portion and a bottom portion; a means to sealed together and enclose the top portion and bottom portion; and a power cord, where said power cord extends from the bottom portion of the enclosure and said power cord includes a connector. The connector enables the connection of the enclosure into a DC outlet of the vehicle.

### BRIEF DESCRIPTION OF DRAWINGS

FIG. 1 depicts a prospective view of a cell phone protector according to the present invention.

### DETAILED DESCRIPTION

The present invention relates to an enclosure to protect a cell phone or other electronic device from extreme environmental conditions within a vehicle when the device is placed within the enclosure. The enclosure according the present invention is placed within a vehicle and and provides an insulated thermal electric case designed to withstand extreme heat and cold temperature conditions. The device may be powered via the vehicle's battery by connecting to a DC outlet within the vehicle such as a cigarette lighter. The present invention therefore protects the electronic device from damage that may occur due to the temperatures within the vehicle and protects the device from the extremes that may fluctuate within the vehicle.

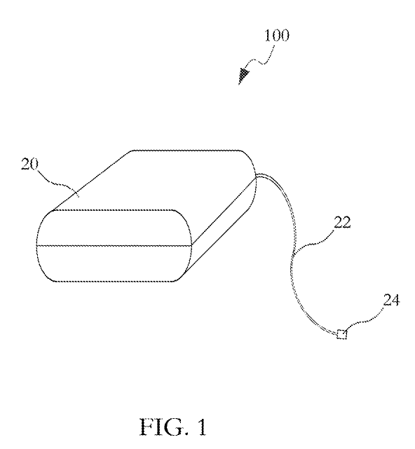

An Enclosure 100 according to the present invention is depicted in FIG. 1. The Enclosure 100 includes a Body Portion 20. The Body Portion 20 includes a top portion and a bottom portion that are sealed together to enclose and protect the electronic device. The top portion may be removed from the bottom portion and the electronic device is placed within the

Enclosure 100 for the protection of the cell phone or other electronic device. The Enclosure 100 includes a Power Cord 22 that extends from the bottom portion of the Enclosure 100. The Power Cord 22 has a Connector 24 at one end thereof to allow for the connection of the Enclosure 100 into a DC outlet of the vehicle. The Enclosure 100 when sealed protects the electronic device from the environmental conditions of the vehicle. The Enclosure 100 is regulated through the use of control mechanisms not shown and therefore keeps the internal temperature of the Enclosure 100 at a reasonable temperature to protect the electronic device.

The Enclosure 100 is thermally electronically insulated and withstands extreme heat or cold temperatures. The Enclosure 100 supplies sufficient heating in an extreme cold environment and sufficient cooling in an extreme hot environment. This protection by the enclosure according to present invention protects any electronic device that may be left within a vehicle. The enclosure is very useful for an individual who may need to leave their electronic devices in their vehicle where they are prohibited from taking the device into a destination. The instant invention has been shown and described in what it considers to be the most practical and preferred embodiments. It is recognized, however, that departures may be made there from within the scope of the invention and that obvious modifications will occur to a person skilled in the art.

What is claimed is:

1. An enclosure for storing an electronic device comprising:
a. a body portion where the body portion includes a top portion and a bottom portion;
b. a means to sealed together and enclose the top portion and bottom portion; and
c. a power cord, where said power cord extends from the bottom portion of the enclosure and said power cord includes a connector

2. The enclosure according to claim 1, where the connector enables the connection of the enclosure into a DC outlet of the vehicle.
